(19) United States
(12) Patent Application Publication
(10) Pub. No.: US 2025/0382460 A1
(43) Pub. Date: Dec. 18, 2025

(54) SILICONE FOAM-FORMING COMPOSITIONS AND SILICONE FOAMS MADE THEREFROM

(71) Applicant: W.R. Meadows, Inc., Hampshire, IL (US)

(72) Inventor: Peter Metelski, Marengo, IL (US)

(21) Appl. No.: 19/222,316

(22) Filed: May 29, 2025

Related U.S. Application Data
(60) Provisional application No. 63/660,262, filed on Jun. 14, 2024.

(51) Int. Cl. C08L 83/04; C08J 9/14; C08K 5/05; C08K 5/5415; C08L 3/02

(52) U.S. Cl. CPC C08L 83/04; C08J 9/141; C08K 5/05; C08K 5/5415; C08L 3/02; C08L 2203/14; C08L 2314/08

(57) ABSTRACT

Silicone foam-forming compositions are disclosed that enable the production of silicone foams having densities <3 lbs/ft³ and as low as 2.0 lbs/ft³ or lower. The compositions comprise methyl hydrogen siloxane, one or more silanols that react with the methyl hydrogen siloxane in the presence of a platinum group catalyst, a long chain alcohol having between 5 and 12 carbon atoms, and starch. The silicone foams resulting from the foam-forming compositions are mechanically stable (non-friable) and do not collapse.

### FIELD OF THE INVENTION

The present technology relates generally to silicone foam-forming compositions and foams made from such compositions. In particular, the present technology relates to silicone foam-forming compositions for preparing low density silicone foams having densities of less than 5 lbs/ft³ (80 kg/m³).

### BACKGROUND

Silicone foams find application in a number of areas. Silicone products tend to be chemically inert, have low flammability, excellent mechanical properties and flame resistance. In the construction industry, silicone foams have application as sealants and gasket materials, thermal insulation and sound insulation. One of the key properties of silicone foam is the density of the foam. The density affects not only the mechanical properties of the foam, but also the economics when compared to other foam options, such as polyurethane foams. Lower density silicone foams can make the foams more economical, since less applied mass is needed for a given foam thickness. Silicone foams with densities in the range of 10-30 lbs/ft³ (160-481 kg/m³) have been known for many years. More recently, workers in the field have developed formulations for producing silicone foams in the region of 5-10 lbs/ft³ (80-160 kg/m³). Even in this range of densities, silicone foams tend to be less economical compared to competing technologies such as polyurethane foams, where densities <1 lbs/ft³ (<16 kg/m³) have been achieved.

One particular difficulty with preparing silicone foams having lower densities in the 5-10 lbs/ft³ (80-160 kg/m³) range is that the physical properties of the foams suffer as the density of silicone foams is reduced. Low density foam tends to become unstable and collapse, and also becomes more mechanically fragile (friable). Thus, preparing silicone foams with acceptable physical properties and densities even lower than 5 lbs/ft³ (80 kg/m³) presents a significant challenge. Mechanical properties of silicone foams can be improved by adding mineral fillers, such as fumed silica, or other fillers, but the addition of such fillers invariably increases the density of the foam.

It would be highly desirable to provide a silicone foam having a density of less than 5 lbs/ft³ (80 kg/m³), and even more desirable to provide a density of 3 lbs/ft³ (48 kg/m³) or less. It would also be highly desirable to provide a low-density foam that does not collapse and is mechanically stable (non-friable) to prevent accidental damage to the foam after installation.

### SUMMARY OF THE INVENTION

The present technology relates to a low-density silicone foam having a density of less than 5 lbs/ft³ (80 kg/m³), preferably 3 lbs/ft3 (48 kg/m³) or less, and as low as 1.5 to 2 lbs/ft³ (24-32 kg/m³). The foam-forming composition is robust, in that the foam does not collapse, even at densities as low as 1.5 to 2 lbs/ft³ (24-32 kg/m³). In some embodiments, the foam-forming composition incorporates starch into the composition, which mechanically stabilizes the foam and prevents it from collapsing. The foam is also non-friable due to the incorporation of alcohols having longer carbon chains, such as C5 to C12, instead of water and lighter alcohols, which tend to produce friable foams. The silicone foam-forming compositions also carefully balance the various chemical reactions taking place, such that the viscosity of the polymerizing silicone is sufficient to capture the hydrogen produced in the blowing reaction. When the foam has reached its maximum height (minimum density), the foam cools and permanently sets, rather than overheating and collapsing.

One aspect of the present technology is a silicone foam-forming composition comprising (i) at least one methyl hydrogen polysiloxane having reactive hydrogens; (ii) optionally, from 0% to about 40% by weight, based on the total weight of the composition, of one or more supplemental blowing agents; (iii) a silanol component comprising one or more silanols having reactive hydroxyl groups; (iv) at least one long-chain alcohol having a carbon chain length in the range of 5 to 12 carbon atoms and reactive hydroxyl groups; (v) optionally, starch; and (vi) a catalyst suitable for catalyzing a reaction between the methyl hydrogen polysiloxane and the silanol component, wherein the composition has a stoichiometric molar ratio of reactive hydrogens to total amount of reactive hydroxyls of 50:1 to 1:1.

In some embodiments, the foam-forming composition is a two-part composition wherein the first part comprises at least the methyl hydrogen polysiloxane, and the second part comprises at least the catalyst. In a preferred embodiment, the first part of the two-part composition comprises the methyl hydrogen polysiloxane and the supplemental blowing agent, and the second part comprises the silanol component, the long-chain alcohol, the starch, and the catalyst.

Another aspect of the present technology is a silicone foam having a density of less than 5 lbs/ft³ (80 kg/m³), wherein the foam is formed from a foam-forming composition comprising (i) at least one methyl hydrogen polysiloxane having reactive hydrogens; (ii) optionally, from 0% to about 40% by weight, based on the total weight of the composition, of one or more supplemental blowing agents; (iii) a silanol component comprising one or more silanols having reactive hydroxyl groups; (iv) at least one long-chain alcohol having a carbon chain length in the range of 5 to 12 carbon atoms and reactive hydroxyl groups; (v) optionally, starch; and (vi) a catalyst suitable for catalyzing a reaction between the methyl hydrogen polysiloxane and the silanol component, wherein the composition has a stoichiometric molar ratio of reactive hydrogens to total amount of reactive hydroxyls of 50:1 to 1:1.

Another aspect of the present technology is a method of preparing a silicone foam comprising (1) providing as foam-forming components, at least one methyl hydrogen polysiloxane having reactive hydrogens; a silanol component comprising one or more silanols having reactive hydroxyl groups; at least one long-chain alcohol having a carbon chain length in the range of 5 to 12 carbon atoms and reactive hydroxyl groups; optionally, starch; a catalyst suitable for catalyzing a reaction between the methyl hydrogen polysiloxane and the silanol component; and optionally, from 0% to about 40% by weight, based on the total weight of the components, of one or more supplemental blowing agents other than a long-chain alcohol; and (2) combining and reacting, under suitable reaction conditions, the foam-forming components to form the silicone foam, wherein the components are combined such that reactive hydrogens from the methyl hydrogen polysiloxane, and reactive hydroxyl groups from the silanol component and the long-chain alcohol, are at a stoichiometric ratio of 50:1 to 1:1.

A further aspect of the present technology is a kit for preparing a silicone foam from a foam-forming composition, wherein the kit comprises (a) components of the foam-forming composition comprising (i) from 5% to 66% by weight, based on the weight of the foam-forming composition of at least one methyl hydrogen polysiloxane having reactive hydrogens, (ii) optionally, from 0% to 40% by weight of a supplemental blowing agent, (iii) a silanol component comprising one or more silanols having reactive hydroxyl groups, (iv) at least one long-chain alcohol having a carbon chain length in the range of 5-12 carbon atoms and reactive hydroxyl groups, (v) optionally, from 0% to about 49% by weight, based on the weight of the foam-forming composition, of starch, and (vi) a catalyst suitable for catalyzing a reaction between the methyl hydrogen polysiloxane and the silanol component, wherein the methyl hydrogen polysiloxane, the silanol component, and the long-chain alcohol are present in the kit in a stoichiometric molar ratio of reactive hydrogens to total amount of reactive hydroxyls of 50:1 to 1:1; (b) a first container comprising a first part of the foam-forming composition, wherein the first part comprises at least the methyl hydrogen polysiloxane; (c) a second container comprising a second part of the foam-forming composition, wherein the second part comprises at least the catalyst; wherein the silanol component, the long-chain alcohol, the supplemental blowing agent, when present, and the starch, when present, are each contained in at least one of the first or second containers; and (d) instructions for reacting the first part of the foam-forming composition with the second part of the foam-forming composition to prepare the silicone foam.

### BRIEF DESCRIPTION OF THE DRAWINGS

FIG. 1 is a graph showing the effect of SiH: OH ratio on foam density.

### DETAILED DESCRIPTION OF THE PREFERRED EMBODIMENTS

While the presently described technology will be described in connection with one or more preferred embodiments, it will be understood by those skilled in the art that the technology is not limited to only those particular embodiments. To the contrary, the presently described technology includes all alternatives, modifications, and equivalents that can be included within the spirit and scope of the appended claims.

The term “about” means +/−10% of the referenced value. In certain embodiments, about means +/−5% of the referenced value, or +/−4% of the referenced value, or +/−3% of the referenced value, or +/−3% of the referenced value, or +/−2% of the referenced value, or +/−1% of the referenced value.

The term “low density” as used herein refers to a foam having a density of less than 5 lbs/ft³ (80 kg/m³).

The silicone foam-forming composition of the present technology comprises (1) a methyl hydrogen polysiloxane component comprising one or more methyl hydrogen polysiloxanes, (2) a silanol component comprising one or more silanols, (3) a long-chain alcohol having a carbon chain length of 5 to 12 carbon atoms, (4) a catalyst suitable for catalyzing a reaction between the methyl hydrogen polysiloxane component and the silanol component, (5) optionally, starch, and (6) optionally, a supplemental blowing agent. The methyl hydrogen polysiloxane has reactive hydrogens (SiH groups) that are reactive toward reactive hydroxyl (OH) groups present in the one or more silanols and the long-chain alcohol. When the components of the foam-forming composition are combined, the reactive hydrogens in the one or more methyl hydrogen polysiloxanes react with the reactive hydroxyl groups in the silanol(s) and the long-chain alcohol. The reaction is exothermic and produces a silicone polymer and hydrogen gas. The hydrogen gas that is formed during the reaction produces bubbles in the silicone polymer and causes foaming.

The relative amounts of the methyl hydrogen polysiloxane component, the silanol component, and the long-chain alcohol present in the silicone foam-forming composition should provide at least an equal stoichiometric ratio of reactive hydrogens from the methyl hydrogen polysiloxane component to reactive hydroxyl groups from the silanol component and the long-chain alcohol. Preferably, there is a stoichiometric excess of reactive hydrogens from the methyl hydrogen polysiloxane component. The stoichiometric ratio of reactive hydrogens to reactive hydroxyl groups can be in the range of 50:1 to 1:1, alternatively 20:1 to 1:1, alternatively 10:1 to 1:1. It is important to balance this SiH: OH stoichiometry correctly in order to generate enough H₂ gas to blow the foam, while also balancing heat generation. Reactions that are too cool will blow slowly and not rise properly. Reactions that are too hot can overheat, causing loss of viscosity, foam collapse, and potentially burning the product.

In some embodiments, the foam-forming composition is a two-part composition that comprises a first part (Part A) comprising the methyl hydrogen polysiloxane component and the supplemental blowing agent (if used), and a second part (Part B) comprising the silanol component, the long-chain alcohol, the catalyst, and starch (if used). The methyl hydrogen polysiloxane in Part A is kept separate from the catalyst in Part B because they tend to react and deactivate. However, it should be appreciated by one skilled in the art that other of the Part B components, or a portion thereof, could be included in Part A if necessary or desired, or that the supplemental blowing agent could be included in Part B. When Part A and Part B are combined, the methyl hydrogen polysiloxane in Part A reacts with the silanol component in Part B to produce the silicone polymer and hydrogen gas, causing foaming.

The following reaction scheme illustrates the reaction.

Part A

Methyl hydrogen siloxane
Supplemental blowing agent

Part B

Silanol fluid
Long-chain alcohol
Starch
Catalyst (Pt)

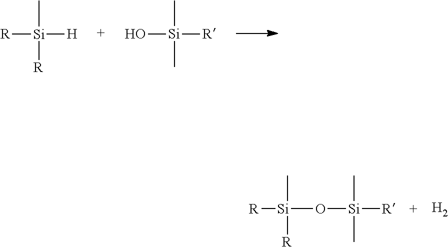

In the formulas above, R has the general formula (CH₃)₃Si—O—(SiCH₃H—O)ₓ—, and R′ has the general formula O(Si(CH₃)₂—O—)_{y}—Si(CH₃)₂OH. The subscripts x and y are integers greater than zero.

When designing a two-part silicone foam composition, it is important to consider the viscosities of Parts A and B. In a well-designed system, Parts A and B have a similar viscosity, leading to efficient blending of the two components. The viscosity of Part A can be in the range of about 0.5 to about 100 cP, alternatively about 1 to about 40 cP, alternatively about 10 to about 20 cP at 25° C. The viscosity of Part B can be in the range of about 0.5 to about 1000 cP, alternatively about 1 to about 600 cP, alternatively about 100 to about 400 cP at 25° C. The blending time of Parts A and B should be short compared to the rising time of the foam. Under ambient conditions, the rising time for the foam can be less than 10 seconds. Consequently, it is useful for the viscosities of Part A and B to be similar, and also to be as low as practical. The most efficient blending to the two parts is achieved when the viscosity of Part A is the same or similar to the viscosity of Part B. The ratio of (viscosity Part A)/(viscosity Part B) should be in the range of 1/100 to 100/1. More preferentially, the ratio of (viscosity Part A)/(viscosity Part B) should be in the range of 1/10 to 10/1. Most preferentially, the ratio of (viscosity Part A)/(viscosity Part B) should be in the range of 1/2 to 2/1.

It will be appreciated by those skilled in the art, that viscosities can be changed by a number of means to suit the needs of the composition preparation. For example, if the foam-forming composition is mixed by adding Part A to Part B, it may be useful for Part A to have a low viscosity, such as about 10 cP to about 100 cP, to make pouring more efficient. Alternatively, if it was desirable to make the viscosity of Part B lower, then the supplemental blowing agent could be moved from Part A to Part B. Similarly, starch, the long-chain alcohol, and/or the silanol component (or a portion thereof) could be moved from Part B to Part A in order to suitably adjust viscosity.

### Methyl Hydrogen Polysiloxane

In general, the methyl hydrogen polysiloxane component of the silicone foam-forming composition comprises any methyl hydrogen polysiloxane having reactive hydrogens (SiH groups) and a viscosity of less than 1000 cP, preferably 100 cP or less, more preferably between 1 and 50 cP at 25° C. In some embodiments, the viscosity of the methyl hydrogen polysiloxane is about 30 cP at 25° C. The amount of the methyl hydrogen polysiloxane in the foam-foaming composition is about 5 wt % to about 66 wt %, alternatively about 32 wt % to about 44 wt % of the total weight of the foam-forming composition.

### Optional Supplemental Blowing Agent

A supplemental blowing agent can be included in Part A or Part B in order to further decrease the density of the silicone foam. The supplemental blowing agent is other than a long-chain alcohol. In principle, any low-boiling solvent, or blends thereof, could be used as the supplemental blowing agent. Examples include butane (bpt=0.5° C.), isobutylene (−7° C.), 2-butene (2° C.), 1-butene (−6° C.), isopentane (29° C.), pentenes (30° C.), 1,4-pentadiene (26° C.), 1,3-pentadiene (42° C.), isoprene (34° C.), cyclohexane (50° C.), isohexane (60° C.), hexane (69° C.), hexadiene (60° C.), and other similar compounds having boiling points between about −20° C. and about 70° C., alternatively between 0° C. and about 60° C., more preferably above 20° C. Supplemental blowing agents can be one or more aliphatic or cycloaliphatic blowing agents having from 4 to 7 carbon atoms. In some embodiments, n-pentane is used as the supplemental blowing agent. Pentane has a relatively low boiling point (36° C.) and vaporizes during the exothermic polymerization reaction. This not only decreases the density of the resulting foam, but also helps control and cool the exotherm of the polymerization reaction, preventing overheating and collapse of the foam product.

Other compounds that could be used as a supplemental blowing agent include hydrofluorocarbons (HFCs) and hydrochlorofluorocarbons (HCFCs), although many of these are being phased out. Hydrofluoroethers (HFEs) and hydrofluoro-olefins (HFOs) are a new generation of blowing agents that also could be used as a supplemental blowing agent.

Carbon dioxide could be used as a supplemental blowing agent, particularly if it were generated in situ, for example, by decomposition of bicarbonate added to the foam-forming composition.

The amount of the supplemental blowing agent can be in the range of 0 wt % up to about 40 wt %, alternatively 0 wt % to about 20 wt %, alternatively 0.5 wt % to about 11 wt %, based on the total weight of the foam-forming composition.

### Silanol Component

The silanol component in the silicone foam-forming composition comprises one or more silanols that are polyorganosiloxanes having at least two reactive hydroxyl groups per molecule. The amount of the silanol component can be in the range of about 15 wt % to about 80 wt %, alternatively about 14 wt % to about 75 wt %, alternatively about 14 wt % to about 70 wt %, based on the total weight of the composition. Considerations for the silanol component include the reactive hydroxyl group content of the silanol and its viscosity. The silanol component should provide sufficient reactive hydroxyl groups to the foam-forming composition such that the stoichiometric ratio of reactive hydrogens to reactive hydroxyl groups in the composition is in the range of 50:1 to 1:1, preferably 10:1 to 1:1. The silanol component also desirably has a viscosity that allows the overall viscosities of Part A and Part B to be similar to enable efficient mixing. The silanol component can be a single silanol, although achieving the combination of sufficient reactive hydroxyl groups and desirable viscosity may be more easily accomplished by using a blend of different silanols.

In some embodiments, the silanol component comprises a blend of at least two silanols, one of which has a low viscosity, in the range of about 10 cP to about 100 cP at 25° C., and another of which has a higher viscosity in the range of about 100 cP to about 2,000 cP at 25° C. Viscosity of the silanols is determined in accordance with ASTM D4283, preferably using a Canon Fenske Viscometer. It has been found that a blend of silanols having different viscosities can provide a balance between the number of reactive hydroxyl groups in the silanol component and a viscosity high enough to capture the hydrogen gas generated from the reaction. In some embodiments, the low viscosity silanol has a viscosity of about 40 cP, and the higher viscosity silanol has a viscosity of about 400 cP. The low viscosity silanol component can comprise about 6 wt % to about 26 wt %, based on the total weight of the foam-forming composition, and the higher viscosity silanol can comprise about 8 wt % to about 46 wt %, alternatively about 25 wt % to about 35 wt %, based on the total weight of the foam-forming composition. The relative amount of higher viscosity silanol to low viscosity silanol is in a weight ratio of about 6:1 to about 1:3.

### Long-Chain Alcohol

The long-chain alcohol reacts with excess methyl hydrogen polysiloxane to produce more hydrogen gas, increasing the amount of foam produced and decreasing the density of the silicone foam. While all alcohols having carbon chain lengths from C1 to C30, as well as their isomers, diols, triols and higher polyols (including sugars) could be expected to function as blowing agents and produce foams, the quality and density of the resulting foams vary depending on the long-chain alcohol used. Water or short chain alcohols, such as methanol and ethanol, tend to react relatively quickly, overheating the reaction, leading to collapse of the resulting foam. In addition, water and short-chain alcohols (C₁-C₄) tend to produce a fragile, friable foam. In the foam-forming composition of the present technology, the long-chain alcohol comprises an alcohol or polyalcohol having a carbon chain length in the range of 5 to 12 carbon atoms and reactive hydroxyl groups. Alcohols having 5 to 12 carbon atoms react more slowly than water or alcohols having shorter chain lengths, limiting the exotherm and thereby stabilizing the foam product. Alcohols having carbon chain lengths longer than 12 carbon atoms tend to react relatively slowly and result in foams having densities higher than 5 lb/ft³ (80 kg/m³). A preferred long-chain alcohol for the foam-forming compositions of the present technology is 1-decanol. Decanol has been found to be advantageous for producing low-density foams that are less friable than those made using water or short-chain alcohols. Blends of alcohols can also be used. These blends can be advantageously used to affect the formation of the foam, and the ultimate properties of the foam product. Blends of alcohols can also be used take advantage of the availability and cost of the alcohol feedstocks. In cold environments, it may be beneficial to use a blend of alcohols containing a fraction of shorter chain alcohol (in the range C1-C6) and a fraction of long chain alcohol (in the range C6-C12). The shorter chain alcohol could provide additional exotherm required to blow the foam in a cold environment. The longer chain alcohol will decrease the friability of the foam product.

The amount of long-chain alcohol in the foam-forming compositions of the present technology can range from about 3 wt % to about 40 wt %, alternatively about 3 wt % to about 20 wt %, alternatively about 3 wt % to about 17 wt %, based on the total weight of the foam-forming composition.

### Catalyst

A catalyst comprising a metal from the platinum group of the periodic table, preferably platinum metal, is used to catalyze the reaction between the reactive hydrogen groups in the methyl hydrogen polysiloxane and the reactive hydroxyl groups in the silanol and the long-chain alcohol. Catalysts that may be used in the present technology are any of the known catalyst forms that are effective in promoting the reaction between the SiH and hydroxyl groups. Exemplary catalysts include Karlstedt catalyst (platinum(0)-1,3-divinyl-1,1,3,3-tetramethyldisiloxane) (see, e.g., U.S. Pat. No. 3,814,730), Ashby's catalyst (Pt(0) complex of tetramethyl-tetravinylcyclotetrasiloxane (see, e.g., U.S. Pat. No. 3,159,601), Lamoreaux's catalyst (Pt(0) octanol/octanal complex (see, e.g., U.S. Pat. No. 3,220,972), and (MeCp)PtMe3 catalyst (Organometallics. 1992, 11, 4194.), Pd(0)TTPP (tetrakis(triphenylphosphine)palladium(0)), chloroplatinic acid, chloroplatinic acid hexahydrate, and platinum dichloride. Additional examples of platinum catalysts are described in U.S. Pat. Nos. 3,419,593; 3,516,946; 3,814,730; 3,989,668; 4,784,879; and 5,175,325; and EP0347895A2.

Compounds of platinum-group metals that can be used as the catalyst include compounds of rhodium, ruthenium, palladium, osmium or iridium metal or combinations thereof (see, e.g. U.S. Pat. Nos. 5,036,117 and 3,296,291). Non-platinum group catalysts can also be used for producing silicone foams. For example, metal catalysts based on zinc, zirconium, magnesium, aluminum, or tin could be used in the silicon curing reaction. Exemplary tin catalysts include stannous octoate and dibutyltin dilaurate.

The catalyst used in the foam-forming compositions can be homogenous, or supported on materials such as silica, carbon, zeolites, or zirconia.

Proper dosing of the platinum or other metal is important to balance the rate of the polymerization reaction (while also limiting the exotherm associated with the reaction) with the production of hydrogen in the blowing agent reaction. The catalyst concentration is selected to give sufficient activity to complete the blowing reaction quickly (less than one minute), and cause the foam to set at maximum height. Too little catalyst can cause the reaction to be slow, with slow heat generation, leading to poorly formed foam. Too much catalyst can lead to overheating of the reaction, loss of viscosity, collapse of the foam, and potentially burning of the foam product. The platinum catalyst concentration is given in ppm of platinum metal based on the total weight of the foam-forming composition. A suitable concentration of catalyst is in the range of about 1 ppm to about 100 ppm platinum group metal, alternatively about 5 ppm to about 75 ppm platinum group metal.

### Starch

In prior art silicone foams, fillers are often added to improve the mechanical properties of the resulting foams, such as toughness, tensile properties, etc. These fillers are often minerals (silica, calcium carbonate, etc.) and are added in quantities approaching 50 wt % of the product foam. While these mineral fillers can improve mechanical properties of the foam, they are detrimental to the density of the foam, and invariably result in higher density.

In the present technology, starch can be blended into the foam-forming composition instead of mineral fillers, and the foam-forming composition is therefore free or essentially free of mineral fillers. Although low density silicone foams of the present technology can be prepared without starch as a component, starch is helpful for reducing the foam density while stabilizing the foam structure, and is preferably included in the foam-forming composition. Without being bound by theory, starch may act as a physical scaffolding that mechanically stabilizes the silicone foam, helping to prevent foam collapse, particularly at low foam density. Starch, in an appropriate amount, can be used to improve the mechanical properties of the foam, while also reducing the density of the foam because hydrogen gas is efficiently trapped.

Starches used in the present technology can be any vegetable starch, as well as starch blends. Sources of the starch include, but are not limited to, arrowroot, wheat, rice, sweet potato, sago and mung bean, maize, cassava, acorns, arracacha, banana, barley, breadfruit, buckwheat, canna, colocasia, cuckoo-pint, katakuri, kudzu, malanga, millet, oat, oca, Polynesian arrowroot, sago, sorghum, taro, chestnut, water chestnut, yam, fava beans, lentil, pea, and chickpea starches. Particularly useful starches include potato starch, corn starch and tapioca starch. In some embodiments, potato starch has been found to be advantageous for the production of low-density silicone foams.

Starches described above can also be chemically modified to change their properties. Any of the modified starches, as well as any of their blends, or blends with unmodified starches, could be used as the starch component. Chemically modified starches include alkaline-modified starch, bleached starch with hydrogen peroxide, oxidized starch with sodium hypochlorite, enzyme-treated starch, monostarch phosphate with phosphorous acid or the salts sodium phosphate, potassium phosphate, or sodium triphosphate, distarch phosphate by esterification, crosslinked starch, acetylated starch by esterification with acetic anhydride, hydroxypropylated starch, starch ether modified with propylene oxide, hydroxyethyl starch, with ethylene oxide, starch sodium octenyl succinate (OSA), starch aluminum octenyl succinate, cationic starch, carboxymethylated starch with monochloroacetic acid. Starches having combined modifications can also be used and include phosphated distarch phosphate, acetylated distarch phosphate, acetylated distarch adipate, hydroxypropyl distarch phosphate, and acetylated oxidized starch.

The amount of the starch can be in an amount of 0 wt % to about 40 wt %, based on the total weight of the foam-forming composition, alternatively about 0.1 wt % to about 40 wt %, alternatively about 0.2 wt % to about 30 wt %, alternatively about 0.2 wt % to about 20 wt %, alternatively about 0.4 wt % to about 17 wt %, alternatively about 0.5 wt % to about 10 wt %, alternatively about 0.5 wt % to about 5 wt %, based on the total weight of the foam-forming composition. The particle size of the starch should be small relative to the size of the cell walls of the foam, and should have a fairly uniform distribution of particle sizes. Particle sizes for the starch can be in the range of about 1 to about 100 microns, alternatively about 1 to about 50 microns. In some embodiments, the starch has an average particle size d50 of about 8 microns, d90 of about 15 microns, and d10 of about 3 microns.

### Other Optional Ingredients

The foam-forming composition of the present technology may contain other ingredients to modify the properties of the foam-forming composition or the resulting foam. For example, other siloxanes, such as vinyl-terminated siloxanes or vinyl-terminated vinylmethyl siloxanes, could be used in combination with the silanol component to provide a portion of the silicone content of the foam.

### Methods of Making Silicone Foams

The present technology also encompasses methods of making the silicone foam-forming compositions and foams. The foam-forming compositions can be prepared by mixing together the methyl hydrogen siloxane, supplemental blowing agent (if used), the silanol component, long-chain alcohol, starch (if used), and catalyst components. The method of mixing is not critical, as long as the method allows the components to be mixed to homogeneity. Mixing can be done by manual stirring, or using standard mixing equipment known to one skilled in the art, such as static mixing equipment, dynamic mixing equipment, or spray equipment.

If the foam-forming composition is a two-part composition, the components in each of Parts A and B are mixed to homogeneity, and Parts A and B are combined and mixed together to form the foam-forming composition and resulting silicone foam. It is envisaged that the 2-part foam forming composition could be sold as a kit, with the components of Part A in one container and the components of Part B in a second container. For example, Part A could include the methyl hydrogen siloxane component and supplemental blowing agent (if used), and the second container could contain the silanol component, long-chain alcohol, starch, and catalyst components. The containers could be pressurized to force the components in each part through the containers to combine and react Part A and Part B together. For example, the containers, such as Froth Pack canisters, could be pressurized with pressurized CO₂ gas or similar, to expel the components and provide mixing energy through a static mixer. The pressures could vary depending on the foam-forming composition and end use. Pressures could be in the range of about 10 psi to 100 psi (69 kPa to 690 kPa) for low pressure spray foams, or in the range of 10 psi to 900 psi (69 kPa to 6,210 kPa) for pour-in-place foam compositions that are sprayed into wall cavities. The kit also includes instructions for reacting Part A and Part B to prepare the silicone foam.

Under ambient temperature, the foam-forming composition of the present technology will begin to foam shortly after mixing has commenced (within a few seconds) and will increase in temperature. The volume of foam could increase about 30× or more compared to the combined volume of the individual components. After the foaming reaction is complete, the foam is allowed to cool and set. The time required for foaming and setting can be in the range of about 1 to 10 minutes or more depending on the particular components and amounts used, the reactivity of the components, and the temperature used. Faster foaming and curing can be achieved by exposing the foam-forming composition to elevated temperatures.

### Silicone Foams and Method of Use

The particular combination of components in the foam-forming composition of the present technology provides a mechanically stable, low-density silicone foam having a density of less than 5 lbs/ft³ (80 kg/m³), and as low as 2.0 lbs/ft³ (32 kg/m³) or lower. The compositions are robust, in that the foams do not collapse due to the incorporation of starch into the silicone formulation. The foams are non-friable due to the incorporation of the long-chain alcohol having from 5 to 12 carbon atoms. The particular combination and amounts of components in the compositions provide a balance of the various chemical reactions taking place, such that the viscosity of the polymerizing silicone is sufficient to fully capture the hydrogen produced in the blowing reaction. When the foam has reached its maximum height (minimum density), the foam cools and permanently sets, rather than overheating and collapsing. Hydrogen gas captured within the foam is exchanged for air within 24-72 hours, depending on applied thickness of the foam, thereby rendering the foam non-flammable. The resulting foam is an open cell foam having a density of less than 5 lbs/ft³ (80 kg/m³), preferably less than 3 lbs/ft³ (48 kg/m³), and as low as 2.0 lbs/ft³ (32 kg/m³) or lower.

Silicone foams have two major advantages over polyurethane foams. The isocyanate used to make polyurethanes is toxic and acts as a sensitizing agent. Human exposure risk exists during manufacturing, storage, handling, and job site application such as spraying. Aerosolized isocyanates are of primary concern during urethane foam installation. Silicone foams contain no isocyanates or other materials representing similar health concerns, and the foam itself is virtually non-toxic. Polyurethane foams are also flammable and frequently require halogenated fire retardants containing chlorine and/or bromine. These fire retardants may also bring associated health concerns. Smoke and toxic gases are also typically generated during the combustion of urethane foams. Silicone foams, on the other hand, are less flammable due to the low carbon content and have low-smoking properties.

The foam-forming compositions of the present technology are useful in a number of applications aimed at the construction industry, such as thermal insulation, acoustic insulation, gasket materials, and gap fillers. The foam-forming compositions may also find use in other applications where temperature resistance and low flammability is desirable. This could include installations such as electronics, furnaces, heaters, and engines. It is believed that the silicone foams also have low-smoke properties compared to organic foams, such as polyurethane or polystyrene. The silicone foams do not evolve toxic gases, such as cyanides, benzene, and lower amounts of CO, CO₂, when burned.

The silicone foams resulting from the foam-forming compositions could be useful in the automotive and aviation industries. The low density of the foam in combination with low flammability may make the silicone foams of the present technology useful in and around engine parts. The foams could also be used in automotive and aviation acoustic and thermal insulation panels due to their low density, low flammability, and low-smoking properties.

In some embodiments, the silicone foams of the present technology may also be useful for replacing any of the common products made using polyurethane foams. These include buoyancy foams used in marine applications, such as boat hulls, buoys, docks etc. The silicone foam may be used to form water-tight seals and fill gaps.

In the mining industry, ground-support polymers and mine-fill polymers are used to reinforce weak ground and to fill voids. These polymers are typically foaming polyurethanes. However, polyurethane foams are unsuitable in some wet locations, or in locations where fire and smoke are a hazard. In some embodiments, the silicone foams of the present technology may provide a viable alternative to polyurethanes in this application.

It is also contemplated that, in some embodiments, silicone foams of the present technology might be useful for the protective packaging industry, where quick foaming, low toxicity and low flammability could be advantageous.

The presently described technology and its advantages will be better understood by reference to the following examples. These examples are provided to describe specific embodiments of the present technology. By providing these specific examples, it is not intended to limit the scope and spirit of the present technology. It will be understood by those skilled in the art that the full scope of the presently described technology encompasses the subject matter defined by the claims appended to this specification, and any alterations, modifications, or equivalents of those claims.

### EXAMPLES

Table A provides trade names and descriptions of various components used in the Examples that follow. Viscosity for the silicone fluids is measured using a Canon Fenske Viscometer@25° C. in accordance with ASTM D4283.

TABLE A

| | |
|---|---|
| MH30 | Methyl hydrogen siloxane, viscosity = 30 cP, available |
| | from AB Specialty Silicones, Waukegan, IL |
| OH30 | Silanol fluid, viscosity = 30 cP, available from |
| | AB Specialty Silicones, Waukegan, IL |
| OH40 | Silanol fluid, viscosity = 40 cP, available from |
| | AB Specialty Silicones, Waukegan, IL |
| OH400 | Silanol fluid, viscosity = 400 cP, available from |
| | AB Specialty Silicones, Waukegan, IL |
| OH750 | Silanol fluid, viscosity = 750 cP, available from |
| | AB Specialty Silicones, Waukegan, IL |
| OH2000 | Silanol fluid, viscosity = 2000 cP, available from |
| | AB Specialty Silicones, Waukegan, IL |
| VS20 | Vinyl-terminated siloxane, viscosity = 20 cP available |
| | from AB Specialty Silicones, Waukegan, IL |
| VDM500 | Vinyl-terminated vinylmethyl siloxane, viscosity = 500 cP, |
| | available from AB Specialty Silicones, Waukegan, IL |

The silicone foams of the Examples and Comparative Examples were prepared according to the following general procedure. The components of Part A of each formulation were added to a cup and mixed together until homogeneous. Separately, the components of Part B of each formulation were added to a cup and mixed together until homogeneous. The Part A mixture was added to the Part B mixture with rapid mixing under ambient conditions and allowed to foam. The foams were allowed to cool and degas overnight.

The mass, volume, and density of the foams of the Examples and Comparative Examples were determined by the following procedures. The mass of foam was obtained by weighing the cup and foam on a laboratory scale and subtracting the tared mass of the sample cup. Volume of foam was measured against graduations on the sample cup. Density was calculated by dividing the observed mass by the observed volume of the product foam. Friability of the foams was qualitatively observed by brushing the foams with a paintbrush. Friable foams tended to easily break into powder when brushed, whereas less friable foams resisted the tendency to break apart when brushed.

### Example 1: Low Density Silicone Foams

Silicone foams from example formulations of the present technology were prepared by the general procedure. The starting materials for each Example formulation are shown in Table 1. The density, volume, and mass of each foam are also reported in Table 1.

TABLE 1
Example recipes for low-density silicone foams

| | Formula | 1 | 2 | 3 | 4 | 5 | 6 |
|---|---|---|---|---|---|---|---|
| Part | MH30 (g) | 6.5 | 6.5 | 6.5 | 6.5 | 6.5 | 6.5 |
| A | Pentane (g) | 0.6 | 0.6 | 0.6 | 0.6 | 0.6 | 0.6 |
| Part | OH-40 (g) | 2.5 | 2.5 | 2.5 | 2.5 | 2.5 | 2.5 |
| B | OH-400 (g) | 5 | 5 | 5 | 5 | 5 | 5 |
| | C₁₀OH (g) | 1.6 | 1 | 1.6 | 1.6 | 1.8 | 1.8 |
| | [Pt] (ppm) | 9 | 9 | 9 | 28 | 28 | 37 |
| | Starch (g) | 3 | 3 | 1 | 1 | 1 | 0.6 |
| | Vol (mL) | 260 | 300 | 340 | 410 | 500 | 485 |
| | Mass (g) | 18.1 | 17.5 | 16.2 | 16.2 | 16.1 | 15.8 |
| | d (lbs/ft³) | 4.3 | 3.6 | 3.0 | 2.5 | 2.0 | 2.0 |

The data in Table 1 show that the density of the silicone foams ranged from 2.0-4.3 lbs/ft³ (32-68.9 kg/m³), and varied depending on the amount of the long-chain alcohol, the amount of the starch, and catalyst amount used in each formulation. The data show that careful balance of the reaction components is required in order to achieve densities of less than 3 lbs/ft³ (48 kg/m³).

### Example 2: Alternative Long-Chain Alcohols

Silicone foams were prepared from formulations in which alternative linear alcohols were used instead of 1-decanol used in the formulations in Example 1. The alternative long-chain alcohols tested were pentanol, octanol, nonanol, undecanol, and dodecanol. The mass of the long-chain alcohols was adjusted to give the same number of OH equivalents in each foam formulation, but the other component amounts were the same for each formulation. The foams were prepared by the general procedure. The foam formulations, and the volume, density, and mass results are shown in Table 2.

TABLE 2
Alternate long-chain alcohols used to produce silicone foams

| | Formula | 7 | 8 | 9 | 10 | 11 |
|---|---|---|---|---|---|---|
| Part | MH30 (g) | 6.5 | 6.5 | 6.5 | 6.5 | 6.5 |
| A | Pentane (g) | 0.6 | 0.6 | 0.6 | 0.6 | 0.6 |
| Part | OH-40 (g) | 2.5 | 2.5 | 2.5 | 2.5 | 2.5 |
| B | OH-400 (g) | 5 | 5 | 5 | 5 | 5 |
| | Alcohol | 1-C₅OH | 1-C₈OH | 1-C₉OH | 1-C₁₁OH | 1-C₁₂OH |
| | Mass alcohol | 1.0 | 1.5 | 1.6 | 2.0 | 2.1 |
| | (g) | | | | | |
| | [Pt] (ppm) | 37 | 37 | 37 | 37 | 37 |
| | Starch (g) | 0.5 | 0.5 | 0.5 | 0.5 | 0.5 |
| | Vol (mL) | 470 | 485 | 485 | 470 | 380 |
| | Mass (g) | 15.3 | 15.5 | 15.8 | 16.2 | 16.3 |
| | d (lbs/ft³) | 2.0 | 2.0 | 2.0 | 2.2 | 2.7 |

The results show that alternative long-chain alcohols can be used to produce low density silicone foams.

Silicone foams were prepared from formulations in which blends of two alcohols were used, and the masses of each were adjusted to give the same number of OH equivalents in each foam formulation. The other components were kept the same in each formulation. The foams were prepared using the same general procedure. The foam formulations, and the volume, mass, and density results are shown in Table 3. In some scenarios, a blend of two or more alcohols could be advantageous. For example, at lower temperature, it could be advantageous to use a shorter chain alcohol which gives a larger exotherm. In some scenarios, economic drivers could make it advantageous to use a blend of two or more alcohols.

TABLE 3
Blends of alcohols used to produce silicone foams

| | Formula | 12 | 13 | 14 | 15 | 16 |
|---|---|---|---|---|---|---|
| Part A | MH30 (g) | 6.5 | 6.5 | 6.5 | 6.5 | 6.5 |
| | Pentane (g) | 0.6 | 0.6 | 0.6 | 0.6 | 0.6 |
| Part B | OH-40 (g) | 2.5 | 2.5 | 2.5 | 2.5 | 2.5 |
| | OH-400 (g) | 5 | 5 | 5 | 5 | 5 |
| | Alcohols | 1-C₅OH/ | 1-C₅OH/ | 1-C₄OH/ | 1-C₄OH/ | 1-C₄OH/ |
| | | 1-C₉OH | 1-C₉OH | 1-C₁₁OH | 1-C₁₀OH | 1-C₁₀OH |
| | Mass alcohol | 0.60/0.90 | 0.40/0.99 | 0.34/1.18 | 0.34/1.08 | 0.50/0.73 |
| | (g) | | | | | |
| | [Pt] (ppm) | 37 | 37 | 37 | 37 | 37 |
| | Starch (g) | 0.5 | 0.5 | 0.5 | 0.5 | 0.5 |
| | Vol (mL) | 485 | 460 | 450 | 450 | 450 |
| | Mass (g) | 15.2 | 14.8 | 15.8 | 15.3 | 15.9 |
| | d (lbs/ft³) | 2.0 | 2.0 | 2.2 | 2.1 | 2.2 |

The results show that blends of alternative long-chain alcohols can be used to produce low density silicone foams.

### Example 3: Effect of Different SiH:OH Ratios

In this Example, the equivalent ratio of SiH to OH groups in the foam formulation was varied to determine the effect of SiH: OH ratio on the density of the foam. Silicone foams were prepared from foam formulations with different equivalents ratios of SiH to OH components. The foams were prepared by the general procedure. The foam formulations, and the volume, density, and mass of the resulting foams are shown in Table 4.

TABLE 4
SiH:OH Ratios

| | Formula | 17 | 18 | 19 | 20 | 21 |
|---|---|---|---|---|---|---|
| | eq Ratio SiH:OH | 7.4 | 19.7 | 29.5 | 39.5 | 49.3 |
| Part A | Mass MH30 (g) | 6.5 | 6.5 | 6.5 | 6.5 | 6.5 |
| | Mass Pentane (g) | 0.6 | 0.6 | 0.6 | 0.6 | 0.6 |
| Part B | Mass OH40 (g) | 2.5 | 0.92 | 0.61 | 0.46 | 0.37 |
| | Mass OH400 (g) | 5 | 1.84 | 1.3 | 0.92 | 0.74 |
| | Mass DeOH (g) | 1.6 | 0.6 | 0.4 | 0.3 | 0.24 |
| | Mass Starch (g) | 0.6 | 0.6 | 0.6 | 0.6 | 0.6 |
| | [Pt] (ppm) | 37 | 37 | 37 | 37 | 37 |
| | Mass (g) | 16.5 | 10.5 | 9.4 | 8.8 | 8.4 |
| | Vol (mL) | 510 | 220 | 160 | 140 | 130 |
| | d (lbs/ft³) | 2.0 | 3.0 | 3.7 | 3.9 | 4.0 |

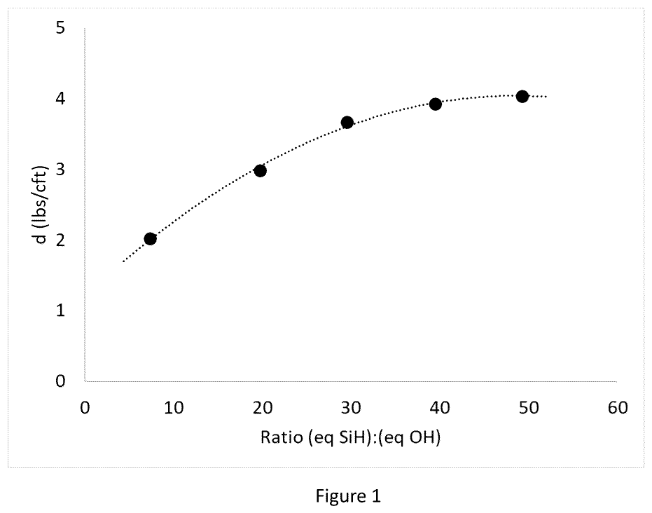

The effect of the SiH:OH equivalents ratio on foam density is shown in FIG. 1. The graph in FIG. 1 shows that the density of the foam increases as the SiH:OH equivalents ratio increases.

### Example 4: Counter-Examples of Silicone Foams (Comparative)

Silicone foams from comparative foam-forming compositions were prepared according to the general procedure. The components and amounts for each comparative formulation are shown in Table 5. The comparative formulations differed from the foam-forming compositions of the present technology in that one or more components of the present foam-forming compositions was missing from the comparative foam formulation, or a different component was substituted for one of the components in the foams of the present technology. Karlstedt catalyst (platinum(0)-1,3-divinyl-1,1,3,3-tetramethyldisiloxane) was used as the catalyst ([Pt]=18 ppm) in all comparative formulations.

TABLE 5
Counter-examples of silicone foams.

| | | | | d | |
|---|---|---|---|---|---|
| Formula | Part A | Part B | Filler | (lbs/ft³) | Comment |
| 22 | MH30 | OH30 (8.8 g), | None | 4.6 | Friable |
| | (10 g) | C₁₀OH (1.2 g) | | | |
| 23 | MH30 | OH40 (10 g), | None | 5.3 | Very friable |
| | (9 g) | water (0.5 g) | | | foam |
| 24 | MH30 | OH40 (4 g), | None | 11 | Collapse |
| | (10 g) | OH2000 (10 g), | | | |
| | | iPrOH (0.5 g) | | | |
| 25 | MH30 | OH40 (4 g), | None | 6.5 | |
| | (10 g) | OH2000 (10 g), | | | |
| | | BuOH (0.5 g) | | | |
| 26 | MH30 | OH40 (4 g), | None | 7.8 | |
| | (10 g) | OH2000 (10 g), | | | |
| | | C₁₀OH (0.5 g) | | | |
| 27 | MH30 | OH40 (4 g), | Fumed | 6.2 | |
| | (10 g) | OH2000 (10 g), | silica (1 g) | | |
| 28 | MH30 | OH40 (4 g), | TiO₂ | 8.2 | |
| | (10 g) | OH2000 (10 g), | (1 g) | | |
| 29 | MH30 | OH40 (4 g), | CaCO₃ | 10.9 | |
| | (10 g) | OH2000 (10 g), | (1 g) | | |
| 30 | MH30 | VS20 (4 g), | None | 3.8 | |
| | (7 g) | VDM500 (2 g), | | | |
| | | C₁₀OH (3 g), | | | |
| | | pentane (1 g) | | | |
| 31 | MH30 | VS20 (4 g), | Fumed | 4.6 | |
| | (7 g) | VDM500 (2 g), | silica | | |
| | | C₁₀OH (3 g), | (3 g) | | |
| | | pentane (1 g) | | | |

All of the foams prepared from the comparative formulations in Table 4, had densities above 3 lbs/ft³ (48 kg/m³). Generally, fillers such as fumed silica, titanium dioxide, and calcium carbonate increased the density of the foam. Short chain alcohols tended to react more quickly than longer chain alcohols, leading to overheating and collapse of the foam. In addition, the short chain alcohols tended to produce a friable foam that was easily damaged. Similarly, although water improved blowing due to the fast formation of hydrogen gas, the reactions tended to overheat, and the resulting foam was highly friable.

### Example 5: Heated Foams

In the above Examples, foaming occurred under ambient conditions. However, since the reaction is exothermic, energy is released during foaming and raises the reaction temperature. Preferred reaction temperatures under ambient conditions are about 21° C. Utilization of professional spray foam equipment permits higher reaction temperatures, since the spray foam equipment allows for the heating of the Part A and Part B spray lines prior to product mixing and spraying. Typical line temperatures can be within the range of about 32° C. (90° F.) to about 54° C. (130° F.). The following formula examples in Table 6 illustrate modifications to the foam-forming composition when foamed under heated conditions.

TABLE 6
Heated Foam Formulations

| | | Formula | | | | | |
|---|---|---|---|---|---|---|---|
| | | 32 | 33 | 34 | 35 | 36 | 37 |
| | | Temperature | | | | | |
| | | 21° C. | 32° C. | 38° C. | 43° C. | 49° C. | 54° |
| Part A | MH30 (g) | 6.5 | 6.5 | 6.5 | 6.5 | 6.5 | 6.5 |
| | Pentane (g) | 0.6 | 0.6 | 0.6 | 0.5 | 0.3 | 0.6 |
| | Hexane (g) | 0 | 0 | 0 | 0.1 | 0.4 | 0.7 |
| Part B | OH-40 (g) | 2.5 | 2.5 | 2.5 | 2.5 | 2.5 | 2.5 |
| | OH-400 (g) | 5 | 5 | 4 | 3 | 2 | 1 |
| | OH-750(g) | 0 | 0 | 1 | 2 | 3 | 4 |
| | C₁₀OH (g) | 1.8 | 1.8 | 1.75 | 1.7 | 1.65 | 1.6 |
| | [Pt] (ppm) | 37 | 20 | 17 | 14 | 12 | 10 |
| | Starch (g) | 0.5 | 0.5 | 0.5 | 0.5 | 0.5 | 0.5 |
| | Vol (mL) | 485 | 470 | 475 | 470 | 170 | 330 |
| | Mass (g) | 15.8 | 16.2 | 16.3 | 16.1 | 16.3 | 16.3 |
| | d (lbs/ft³) | 2.0 | 2.2 | 2.1 | 2.1 | 6.0 | 3.1 |

Higher reaction temperatures may allow the utilization of silanols having a higher molecular weight and viscosity, without increasing viscosity of the composition. Other formulation modifications due to higher reaction temperatures may include adding a supplemental blowing agent having a higher boiling point, such as hexane, reducing the amount of long-chain alcohol, and reducing the amount of platinum catalyst.

The present technology is now described in such full, clear and concise terms as to enable a person skilled in the art to which it pertains, to practice the same. It is to be understood that the foregoing describes preferred embodiments of the present technology and that modifications may be made therein without departing from the spirit or scope of the present technology as set forth in the appended claims. Further, the examples are provided to not be exhaustive but illustrative of several embodiments that fall within the scope of the claims.

1. A silicone foam-forming composition comprising:
(a) at least one methyl hydrogen polysiloxane having reactive hydrogens;
(b) optionally, from 0% to about 40% by weight, based on the total weight of the composition, of one or more supplemental blowing agents;
(c) a silanol component comprising one or more silanols having reactive hydroxyl groups;
(d) at least one long-chain alcohol having a carbon chain length in the range of 5 to 12 carbon atoms and reactive hydroxyl groups;
(e) optionally, from 0% to about 49% by weight, based on the total weight of the composition, of starch; and
(f) a catalyst suitable for catalyzing a reaction between the methyl hydrogen polysiloxane and the silanol component,
wherein the composition has a stoichiometric molar ratio of reactive hydrogens to total amount of reactive hydroxyls of 50:1 to 1:1.

2. The composition of claim 1, wherein the methyl hydrogen polysiloxane is in an amount of 5% to 66% by weight, preferably 32%-44% by weight based on the total weight of the composition.

3. The composition of claim 1, wherein the supplemental blowing agent is present in the composition in an amount of 0.5% by weight to 40% by weight, based on the total weight of the composition, preferably 0.5% to 11% by weight.

4. The composition of claim 1, wherein the supplemental blowing agent is an aliphatic or cycloaliphatic blowing agent having from 4 to 7 carbon atoms, preferably pentane, and optionally has a boiling point of −20° C. to 70° C.

5. The composition of claim 1, wherein the silanol component is in an amount of about 14% to about 80%, preferably about 14% to about 70% by weight based on the total weight of the composition.

6. The composition of claim 1, wherein the silanol component comprises a blend of two or more silanol components, wherein the blend of silanol components comprises a low viscosity silanol having a viscosity of about 10 cP to about 100 cP, and a higher viscosity silanol having a viscosity of about 100 cP to about 2000 cP, wherein the low viscosity silanol is in an amount of about 6% to about 26% by weight, and the higher viscosity silanol is in an amount of about 8% to about 46% by weight, based on the total weight of the composition.

7. The composition of claim 6, wherein the low viscosity silanol and the higher viscosity silanol are in a weight ratio of higher viscosity silanol to low viscosity silanol of about 6:1 to 1:3, preferably about 2:1.

8. The composition of claim 1, wherein the long-chain alcohol is in an amount of about 3% to about 40% by weight, preferably about 3% to about 17% by weight, based on the total weight of the composition.

9. The composition of claim 1, wherein the starch is in an amount of about 0.1% to about 49% by weight, preferably about 0.4% to about 17% by weight, based on the total weight of the composition, and optionally has a particle size in the range of about 1 micron to about 100 microns.

10. The composition of claim 1, wherein the catalyst is a platinum-group catalyst in an amount of about 1 ppm to about 100 ppm, preferably 9 ppm to 74 ppm platinum-group metal, based on total weight of the composition.

11. The composition of claim 1, wherein the composition is essentially free of mineral fillers.

12. The composition of claim 1, wherein the composition is a 2-part composition having a first part and a second part, wherein the first part comprises:
(i) the methyl hydrogen polysiloxane in an amount of 5% to 66% by weight, based on the total weight of the composition,
(ii) optionally up to 100% of the amount of supplemental blowing agent,
(iii) optionally up to 100% of the amount of the silanol component,
(iv) optionally up to 100% of the amount of the long-chain alcohol, and
(v) optionally up to 100% of the amount of the starch, and
wherein the second part comprises:
(i) the catalyst in an amount of 1 ppm to about 100 ppm,
(ii) optionally up to 100% of the amount of supplemental blowing agent,
(iii) optionally up to 100% of the amount of the silanol component,
(iv) optionally up to 100% of the amount of the long-chain alcohol, and
(v) optionally up to 100% of the amount of the starch,
with the proviso that the silanol component, the long-chain alcohol, the supplemental blowing agent, when present, and the starch, when present, are contained in at least one of the first part or the second part.

13. The composition of claim 12, wherein the first part comprises the methyl hydrogen polysiloxane and the supplemental blowing agent, and the second part comprises the silanol component, the long-chain alcohol, the starch, and the catalyst.

14. The composition of claim 13, wherein first part has a viscosity of about 0.5 to about 100 cP at 25° C., preferably about 1 to about 40 cP at 25° C., more preferably about 10 to about 20 cP at 25° C., and wherein the second part has a total viscosity of about 0.5 to about 1000 cP at 25° C., preferably about 1 to about 600 cP at 25° C., more preferably about 100 to about 400 cP at 25° C.

15. A silicone foam formed from the silicone foam-forming composition of claim 1, wherein the silicone foam has a density of less than 5 lb/ft³ or less, preferably 3 lb/ft³ or less.

16. The silicone foam of claim 15, wherein the foam is an open cell foam, a spray foam, a pour-in-place foam, or a froth pack foam.

17. A method for preparing a silicone foam comprising:
(1) providing
(a) at least one methyl hydrogen polysiloxane having reactive hydrogens;
(b) a silanol component comprising one or more silanols having reactive hydroxyl groups;
(c) at least one long-chain alcohol having a carbon chain length in the range of 5 to 12 carbon atoms and reactive hydroxyl groups;
(d) optionally, starch;
(e) a catalyst suitable for catalyzing a reaction between the methyl hydrogen polysiloxane and the silanol component; and
(f) optionally, one or more supplemental blowing agents other than a long-chain alcohol; and
(2) combining and reacting, under suitable reaction conditions, components (a) through (f) to form the silicone foam, wherein the components are combined such that reactive hydrogens from the methyl hydrogen polysiloxane, and reactive hydroxyl groups from the silanol component and the long-chain alcohol, are at a stoichiometric ratio of 50:1 to 1:1.

18. The method of claim 17, wherein the method comprises providing a first part comprising the methyl hydrogen polysiloxane and optionally, the supplemental blowing agent, and a second part comprising the silanol component, the long-chain alcohol, the starch, and the catalyst.

19. The method of claim 18, wherein first part and the second part are combined and reacted by spraying the first part and the second part together, optionally wherein the spraying occurs at a pressure of about 10 psi to about 900 psi.

20. The method of claim 18, wherein the first part and the second part are combined and reacted by mixing the first part and the second part together in a pre-made form.
